(19) United States
(12) Patent Application Publication
(10) Pub. No.: US 2020/0199302 A1
(43) Pub. Date: Jun. 25, 2020

(54) ORGANIC SILICON COMPOUND-MODIFIED COPOLYMER AND URETHANE COMPOSITION INCLUDING SAME

(71) Applicant: SHIN-ETSU CHEMICAL CO., LTD., Tokyo (JP)

(72) Inventors: Munenao HIROKAMI, Annaka-shi (JP); Yuji ANDO, Annaka-shi (JP)

(73) Assignee: SHIN-ETSU CHEMICAL CO., LTD., Tokyo (JP)

(21) Appl. No.: 16/617,780

(22) PCT Filed: Apr. 10, 2018
(86) PCT No.: PCT/JP2018/015009

§ 371 Date: Nov. 27, 2019

(30) Foreign Application Priority Data
May 29, 2017 (JP) 2017-105270

(51) Int. Cl. C08G 77/08; C08L 75/04; C08G 77/38

(52) U.S. Cl. CPC C08G 77/08; C08K 5/5419; C08G 77/38; C08L 75/04

(57) ABSTRACT

An organic silicon compound-modified copolymer having structural units represented by formula (1) and formula (2) and having a hydroxyl group at at least one end has excellent compatibility with alcohol compounds and isocyanate compounds and also gives a cured product having excellent water repellency and moisture resistance.

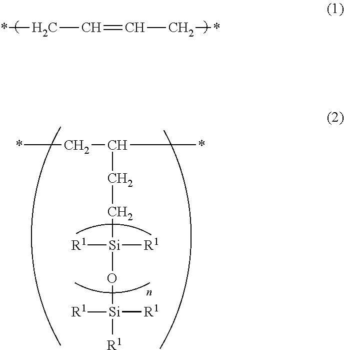

(In the formulas, an asterisk * represents a bond to an adjacent structural unit, each R¹ independently represents a C1-10 alkyl group or C6-10 aryl group, and n represents an integer of 1 or higher.)

### TECHNICAL FIELD

The present invention relates to an organic silicon compound-modified copolymer and a urethane composition including the same, and more specifically, relates to a specific organic silicon compound-modified copolymer including a polybutadiene skeleton, a polysiloxane skeleton, and a hydroxyl group at at least one end, and a urethane composition including the same.

### BACKGROUND ART

As a urethane composition, a urethane composition incorporating a carbinol-modified polysiloxane has been conventionally proposed (see Patent Documents 1 and 2). By containing polysiloxane, the water repellency on the surface of a cured product can be exhibited.

However, the conventional carbinol-modified polysiloxane has very poor compatibility with alcohol compounds and isocyanate compounds, compounds incorporated in the urethane composition, and mixing them uniformly is difficult.

Also, a cured product of urethane obtained by curing a urethane composition incorporating the conventional carbinol-modified polysiloxane has high moisture permeability, and has a problem of easily causing deterioration of the substrate and peeling of the cured product film due to moisture when the cured product is used as a paint or a protective film.

### PRIOR ART DOCUMENTS

### Patent Documents

Patent Document 1: JP-B H07-33427

Patent Document 2: JP-B H07-53789

### SUMMARY OF INVENTION

### Technical Problem

The present invention has been made in consideration of the above circumstances, and an object to provide an organic silicon compound-modified copolymer that has excellent compatibility with alcohol compounds and isocyanate compounds and also gives a cured product having excellent water repellency and moisture resistance, and an urethane composition including the same.

### Solution to Problem

As a result of intensive studies to solve the above-mentioned problems, the present inventors have found that a specific organic silicon compound-modified copolymer including a polybutadiene skeleton, a polysiloxane skeleton, and a hydroxyl group at at least one end has excellent compatibility with alcohol compounds and isocyanate compounds and also gives a cured product having excellent water repellency and moisture resistance, thereby completing the present invention.

That is, the present invention provides the following.

1. An organic silicon compound-modified copolymer including: a structural unit of formula (1) below; a structural unit of formula (2) below; and a hydroxyl group at at least one end:

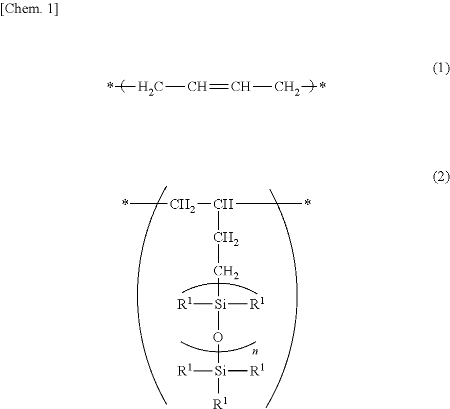

wherein asterisk * is a bond to an adjacent structural unit, R¹ is each independently a C₁-C₁₀ alkyl group or C₆-C₁₀ aryl group, and n is an integer of 1 or higher.
2. The organic silicon compound-modified copolymer of 1, having a number average molecular weight of 1,000 or higher.
3. A production method of the organic silicon compound-modified copolymer of 1 or 2, including the step of: hydrosilylating a polybutadiene compound including a structural unit of formula (1) below, a structural unit of formula (3) below, and a hydroxyl group at at least one end with a silicone compound of formula (4) below in presence of a platinum compound-containing catalyst:

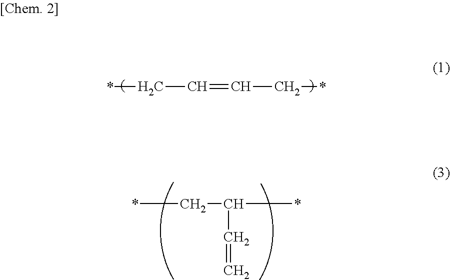

wherein asterisk * has a meaning same as above,

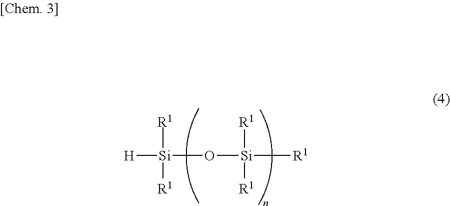

wherein R¹ and n have a meaning same as above.
4. A urethane composition including the organic silicon compound-modified copolymer of 1 or 2.

### Advantageous Effects of Invention

The organic silicon compound-modified copolymer of the present invention has good compatibility with alcohol compounds and isocyanate compounds, and the urethane composition including the organic silicon compound-modified copolymer is capable of giving a cured product having excellent water repellency and moisture resistance.

### DESCRIPTION OF EMBODIMENTS

Hereinafter, the present invention is specifically described.

The organic silicon compound-modified copolymer according to the present invention includes a structural unit represented by formula (1) below; a structural unit represented by formula (2) below; and a hydroxyl group at at least one end:

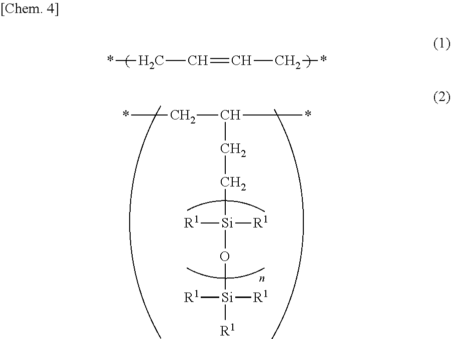

wherein asterisk * is a bond to an adjacent structural unit.

In formula (2), R¹ is each independently a C₁-C₁₀ alkyl group or C₆-C₁₀ aryl group.

The C₁-C₁₀ alkyl group can be linear, cyclic or branched, and specific examples thereof include methyl, ethyl, n-propyl, i-propyl, n-butyl, s-butyl, t-butyl, n-pentyl, n-hexyl, n-heptyl, n-octyl, n-nonyl, n-decyl, cyclopropyl, cyclobutyl, cyclopentyl, cyclohexyl, cycloheptyl, and cyclooctyl groups.

Specific examples of the C₆-C₁₀ aryl group include phenyl, α-naphthyl, and β-naphthyl groups.

Among these, as R¹, a linear alkyl group is preferable, and a methyl group, an ethyl group, and an n-butyl group are more preferable.

In formula (2) above, though n is an integer of 1 or higher, an integer of 4 or higher is preferable and an integer of 8 or higher is more preferable considering further increasing the water repellency of the obtained cured product. Though the upper limit is not particularly limited, 100 or less is preferable.

Though the molecular weight of the organic silicon compound-modified copolymer is not particularly limited, the organic silicon compound-modified copolymer preferably has a number average molecular weight of 1,000 or higher, and more preferably 1,200 or higher.

The number average molecular weight is a polystyrene-equivalent number average molecular weight obtained by gel permeation chromatography (GPC).

In the organic silicon compound-modified copolymer, the total number of the structural units represented by formula (1) and formula (2) above preferably occupies 30 mol% or higher, more preferably 50 mol% or higher, and still more preferably 80 mol% or higher in all units that constitute the copolymer.

In particular, considering improving compatibility with alcohol compounds and isocyanate compounds and reducing moisture permeability of the cured product, the structural unit having the polybutadiene skeleton represented by formula (1) preferably occupies 10% by weight or higher, and more preferably 40% by weight or higher in all units that constitute the organic silicon compound-modified copolymer.

Further, considering further increasing the water repellency of the cured product, the number of the structural unit having a polysiloxane skeleton represented by formula (2) preferably occupies 5% by weight or higher, and more preferably 10% by weight or higher.

The organic silicon compound-modified copolymer can include, in addition to the structural unit of formula (1) and the structural unit of formula (2) above, the structural unit of formula (3) below and the structural unit of formula (5), and the arrangement of each structural unit is arbitrary:

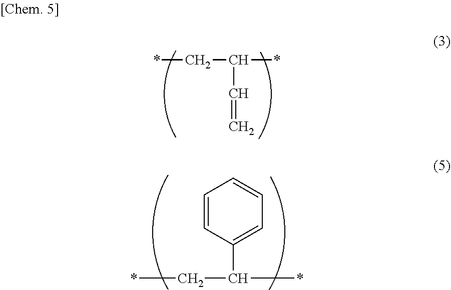

wherein asterisk * has a meaning same as above.

Though the organic silicon compound-modified copolymer includes at least one hydroxyl group per molecule at the end on average, the organic silicon compound-modified copolymer preferably includes 1.5 or higher hydroxyl groups at the end per molecule on average, and more preferably includes two or higher hydroxyl groups at the end per molecule on average.

The organic silicon compound-modified copolymer described above is obtained by hydrosilylating a polybutadiene compound including a structural unit of formula (1), a structural unit of formula (3), and a hydroxyl group at at least one end with a silicone compound of formula (4) in presence of a platinum compound-containing catalyst:

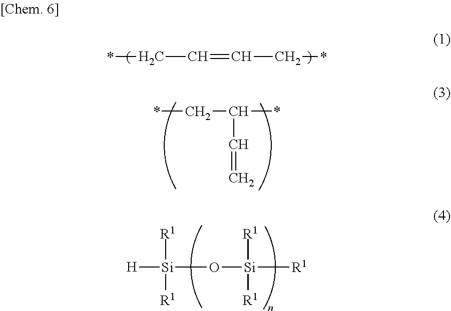

wherein asterisk *, R¹, and n have a meaning same as above.

Examples of the polybutadiene compound including the structural unit of formula (1), a structural unit of formula (3), and a hydroxyl group at at least one end include a butadiene homopolymer, a butadiene/styrene copolymer, and a butadiene/isoprene copolymer, and these are also commercially available. For example, as a butadiene homopolymer, Poly bd R-15HT (manufactured by Idemitsu Kosan Co., Ltd.), Poly bd R-45HTLO, Poly bd R-20LM, Poly bd 605E, Krasol LBH 2000, Krasol LBH-P 2000, Krasol LBH 3000, Krasol LBH-P 3000 (those above are manufactured by CRAY VALLEY) are newly available.

Meanwhile, the silicone compound of formula (4) is not particularly limited as long as it has a Si—H group at one end, and specific examples thereof include the silicone compounds of formulas (6) to (11):

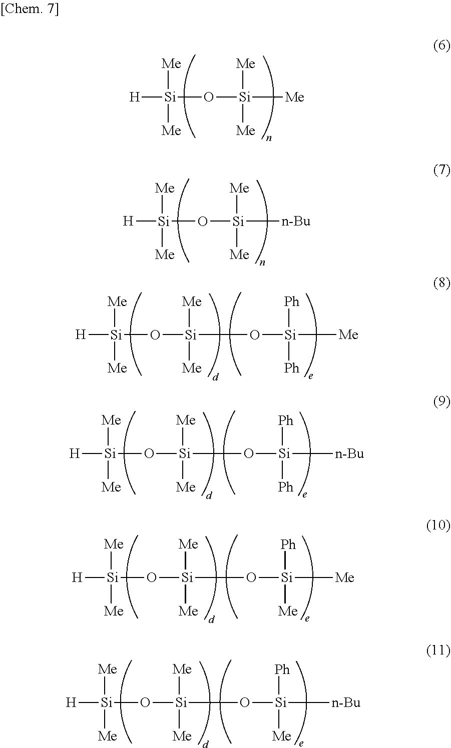

wherein though n has a meaning same as above, an integer of 8 to 100 is preferable, and d is an integer of 1 or higher, e is an integer of 1 or higher, and d+e=n, provided that the order of each repeating unit is arbitrary in formulas (6) to (11).

The platinum compound-containing catalyst used in the hydrosilylation reaction is not particularly limited, and specific examples thereof include platinic chloride, an alcohol solution of platinic chloride, platinum-1,3-divinyl-1,1,3,3-tetramethyldisiloxane complex in toluene or xylene, tetrakistriphenylphosphine platinum, dichlorobistriphenylphosphine platinum, dichlorobisacetonitrile platinum, dichlorobisbenzonitrile platinum, dichlorocyclooctadiene platinum, and supported catalysts such as a platinum-carbon catalyst, a platinum-alumina catalyst and a platinum-silica catalyst.

From the viewpoint of selectivity during hydrosilylation, a zero-valent platinum complex is preferable, and a platinum-1,3-divinyl-1,1,3,3-tetramethyldisiloxane complex in toluene or xylene is more preferable.

Though the amount used of the platinum compound-containing catalyst is not particularly limited, from the viewpoint of reactivity, productivity and the like, it is preferably 0.1 to 100 ppm (as a platinum amount) per the total weight of the polybutadiene compound including the structural unit represented by formula (1), the structural unit represented by formula (3), and a hydroxyl group at at least one end, and the silicone compound represented by formula (4).

Though the above-mentioned reaction proceeds even without a solvent, a solvent can be used.

Specific examples of the solvent that can be used include hydrocarbon solvents such as pentane, hexane, cyclohexane, heptane, isooctane, benzene, toluene, and xylene; ether solvents such as diethyl ether, tetrahydrofuran, and dioxane; ester solvents such as ethyl acetate and butyl acetate; aprotic polar solvents such as N, N-dimethylformamide; and chlorinated hydrocarbon solvents such as dichloromethane and chloroform, and these solvents can be used alone or in combination of two or more types.

The reaction temperature in the hydrosilylation reaction is not particularly limited, the reaction can be performed from 0° C. with heating, but the temperature is preferably 0 to 200° C.

To obtain a moderate reaction rate, the reaction is preferably performed with heating. From such a viewpoint, the reaction temperature is more preferably 40 to 110° C., still more preferably 40 to 90° C.

The reaction time is not particularly limited, and is usually about 1 to 60 hours, preferably 1 to 30 hours, and more preferably 1 to 20 hours.

The urethane composition of the present invention includes the above-mentioned organic silicon compound-modified copolymer.

Though the concentration of the organic silicon compound-modified copolymer contained in the urethane composition is not particularly limited, the concentration is preferably 1 to 95% by weight, more preferably 5 to 80% by weight, and still more preferably 10 to 70% by weight per the entire composition. When the concentration is within these ranges, the cured product of the urethane composition itself can have uniform and excellent water repellency and moisture resistance.

Further, the urethane composition can include a hydroxyl group-containing compound or an isocyanate group-containing compound.

The hydroxyl group-containing compound used in the present invention is not particularly limited as long as it is a hydroxyl group compound (polyol) having two or higher hydroxyl groups in one molecule, and the hydroxyl group-containing compound can be appropriately selected from known compounds and used.

Examples of the polyol include low molecular weight polyols such as ethanediol, propanediol, 1,4-butanediol, 1,6-hexanediol, cyclohexyldimethanol, methylpropanediol, neopentylglycol, butylethylpropanediol, glycerin, trimethylolethane, trimethylolpropane, polycaprolactone triol, ditrimethylolpropane, pentaerythritol, polycaprolactone tetraol, dipentaerythritol, sorbitol, and mannitol; polyether polyols obtained by reacting an alkylene polyol such as ethylene glycol and propylene glycol with an alkylene oxide such as ethylene oxide and propylene oxide; polyester polyols obtained by reacting a polycarboxylic acid such as maleic acid and phthalic acid with an alkylene polyol such as ethylene glycol and propylene glycol; polycarbonate diols obtained by reacting an alkylene carbonate such as ethylene carbonate or trimethylene carbonate with an alkylene polyol such as ethylene glycol and 1,3-propanediol; homopolymers of a hydroxyl group-containing acrylic monomers such as 2-hydroxyethyl (meth)acrylate and hydroxypropyl (meth)acrylate, and copolymers with a radically polymerizable unsaturated monomer such as acrylic acid or styrene. These can be used alone or in combination of two or more types.

As the isocyanate group-containing compound, conventionally known ones can be used, and examples thereof include toluene-2,4-diisocyanate, 4-methoxy-1,3-phenylene diisocyanate, 4-isopropyl-1,3-phenylene diisocyanate, 4-chloro-1,3-phenylene diisocyanate, 4-butoxy-1,3-phenylene diisocyanate, 2,4-diisocyanate-diphenyl ether, methylene diisocyanate, 4,4′-methylenebis (phenyl isocyanate), durylene diisocyanate, 1,5-naphthalene diisocyanate, benzidine diisocyanate, o-nitrobenzidine diisocyanate, 4,4′-diisocyanate dibenzyl, 1,4-tetramethylene diisocyanate, 1,6-tetramethylene diisocyanate, 1,10-decamethylene diisocyanate, 1,4-cyclohexylene diisocyanate, xylylene diisocyanate, 4,4′-methylenebis (cyclohexyl isocyanate), and 1,5-tetrahydronaphthalene diisocyanate.

In the present invention, the isocyanate group and the hydroxyl group are preferably incorporated so that the equivalent ratio of the isocyanate group to the hydroxyl group (NCO/OH) in the urethane composition will be 0.25 to 5.0, more preferably in the range of 0.5 to 3.0, and still more preferably 0.8 to 2.0. When the amounts incorporated are in such a range, the crosslink density of the cured product is increased, and for example, durability can be imparted to the cured product.

Meanwhile, when the amount of the polyisocyanate incorporated is less than 0.25, a part of hydroxyl groups in the polyol remains without being reacted, which may result in the deterioration of the durability of the cured product such as moisture resistance and weatherability. Meanwhile, when the amount of the polyisocyanate incorporated is more than 5.0, the isocyanate group in polyisocyanate remains without being reacted, which may also result in the deterioration of the durability such as moisture resistance and weatherability. In this specification, the equivalent ratio of the isocyanate group in polyisocyanate to the hydroxyl group in polyol (NCO/OH) refers to the ratio of the total number of NCO groups in polyisocyanate to the total number of OH groups in polyol contained in the curable composition.

For example, to adjust the solid content in the urethane composition, dilution with a diluting solvent can be performed.

As the diluting solvent, an alcohol solvent, a carboxylic acid ester solvent, a ketone solvent, an amide solvent, an ether solvent, or aliphatic and aromatic hydrocarbon organic solvents are used.

Examples of the alcohol solvent include methanol, isopropyl alcohol, n-butanol, diacetone alcohol, 2-methoxyethanol (methyl cellosolve), 2-ethoxyethanol (ethyl cellosolve), 2-butoxyethanol (butyl cellosolve), and tertiary amyl alcohol; examples of the carboxylic acid ester solvent include ethyl acetate, n-propyl acetate, butyl acetate, and butyl formate; examples of the ketone solvent include methyl ethyl ketone, methyl isobutyl ketone, acetone, and cyclohexanone; examples of the amide solvent include dimethylformamide and dimethylacetamide; examples of the ether solvent include diethyl ether, methoxytoluene, 1,2-dimethoxyethane, 1,2-dibutoxyethane, 1,1-dimethoxymethane, 1,1-dimethoxyethane, 1,4-dioxane, and tetrahydrofuran; and examples of the aliphatic and aromatic hydrocarbon solvents include hexane, pentanexylene, toluene, and benzene. These organic solvents can be used alone or in combination of two or more types.

In addition to the components described above, various additives can be added to the urethane composition of the present invention. Examples of the additive include a curing catalyst, a metal oxide, a resin, a dye, a pigment, an ultraviolet absorber, and an antioxidant, and specific examples thereof include silica gel, titania sol, and alumina sol.

### EXAMPLES

Hereinafter, though the present invention is more specifically described by way of Examples and Comparative Examples, the present invention is not limited to these Examples.

In the following, “part” means part by weight. The molecular weight is a polystyrene-equivalent number average molecular weight determined by GPC measurement. The viscosity is a value at 25° C. measured using a rotational viscometer.

### [1] Production of Organic Silicon Compound-Modified Copolymer

### [Example 1-1] Production of Organic Silicon Compound-Modified Copolymer A

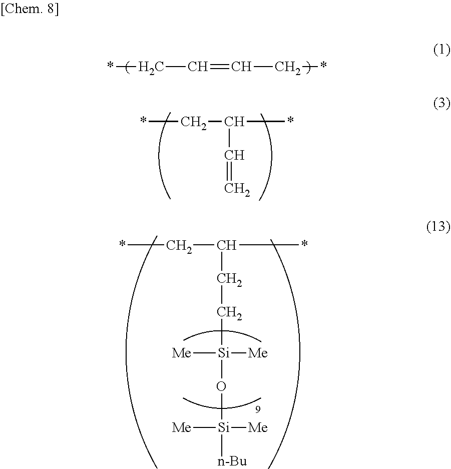

wherein asterisk * has a meaning same as above.

Into a 1 L separable flask equipped with a stirrer, a reflux condenser, a dropping funnel, and a thermometer, 400 g of Poly bd R-15HT (manufactured by Idemitsu Kosan Co., Ltd., the number average molecular weight of 1,200, composed of structural units of formulas (1) and (3) above, (1)/(3)=80/20 (molar ratio, the same applies hereinafter), OH value of 100 mg KOH/g, the number of hydroxyl groups per molecule of 2.2, the same applies hereinafter), 100 g of a silicone compound represented by formula (12) below, 300 g of toluene, and platinum-1,3-divinyl-1,1,3,3-tetramethyldisiloxane complex in toluene (5 ppm in terms of platinum atoms) are added and stirred at 100° C. for 8 hours. It was confirmed by ¹H-NMR measurement that the Si—H group had disappeared. Then, the resulting product was subjected to distillation under reduced pressure and filtration to obtain a pale yellow and slightly turbid liquid. The number average molecular weight was 1,500, and it was suggested from this number average molecular weight that the obtained silicone compound was an organic silicon compound-modified copolymer A composed of units represented by formulas (1), (3) and (13) above. The OH value was 80 mg KOH/g, and the number of the hydroxyl group per molecule was 2.2.

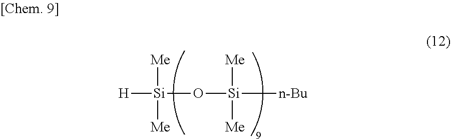

### [Example 1-2] Production of Organic Silicon Compound-Modified Copolymer B

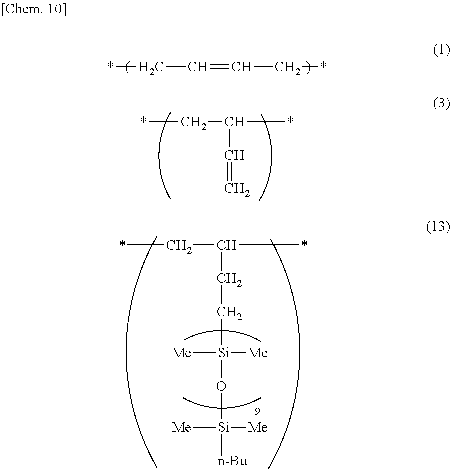

wherein asterisk * has a meaning same as above.

Into a 1 L separable flask equipped with a stirrer, a reflux condenser, a dropping funnel, and a thermometer, 250 g of Poly bd R-15HT, 250 g of a silicone compound represented by formula (12) above, 300 g of toluene, and platinum-1,3-divinyl-1,1,3,3-tetramethyldisiloxane complex in toluene (5 ppm in terms of platinum atoms) are added and stirred at 100° C. for 8 hours. It was confirmed by ¹H-NMR measurement that the Si—H group had disappeared. Then, the resulting product was subjected to distillation under reduced pressure and filtration to obtain a pale yellow and slightly turbid liquid. The number average molecular weight was 2,400, and it was suggested from this number average molecular weight that the obtained silicone compound was an organic silicon compound-modified copolymer B composed of units represented by formulas (1), (3) and (13) above. The OH value was 50 mg KOH/g, and the number of the hydroxyl group per molecule was 2.2.

### [Example 1-3] Production of Organic Silicon Compound-Modified Copolymer C

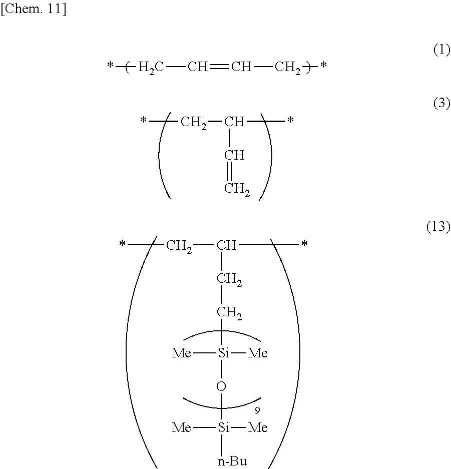

wherein asterisk * has a meaning same as above.

Into a 1 L separable flask equipped with a stirrer, a reflux condenser, a dropping funnel, and a thermometer, 150 g of Poly bd R-15HT, 350 g of a silicone compound represented by formula (12) above, 300 g of toluene, and platinum-1,3-divinyl-1,1,3,3-tetramethyldisiloxane complex in toluene (5 ppm in terms of platinum atoms) are added and stirred at 100° C. for 8 hours. It was confirmed by ¹H-NMR measurement that the Si—H group had disappeared. Then, the resulting product was subjected to distillation under reduced pressure and filtration to obtain a pale yellow and slightly turbid liquid. The number average molecular weight was 4,000, and it was suggested from this number average molecular weight that the obtained silicone compound was an organic silicon compound-modified copolymer C composed of units represented by formulas (1), (3) and (13) above. The OH value was 30 mg KOH/g, and the number of the hydroxyl group per molecule was 2.2.

### [Example 1-4] Production of Organic Silicon Compound-Modified Copolymer D

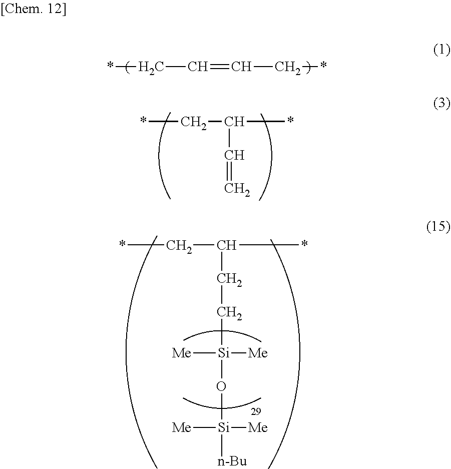

wherein asterisk * has a meaning same as above.

Into a 1 L separable flask equipped with a stirrer, a reflux condenser, a dropping funnel, and a thermometer, 400 g of Poly bd R-15HT, 100 g of a silicone compound represented by formula (14) below, 300 g of toluene, and platinum-1,3-divinyl-1,1,3,3-tetramethyldisiloxane complex in toluene (5 ppm in terms of platinum atoms) are added and stirred at 100° C. for 8 hours. It was confirmed by ¹H-NMR measurement that the Si—H group had disappeared. Then, the resulting product was subjected to distillation under reduced pressure and filtration to obtain a pale yellow and slightly turbid liquid. The number average molecular weight was 1,500, and it was suggested from this number average molecular weight that the obtained silicone compound was an organic silicon compound-modified copolymer D composed of units represented by formulas (1), (3) and (15) above. The OH value was 80 mg KOH/g, and the number of the hydroxyl group per molecule was 2.2.

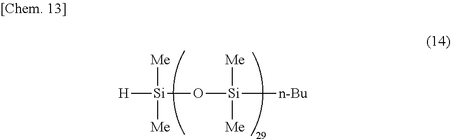

### [Example 1-5] Production Method of Organic Silicon Compound-Modified Copolymer E

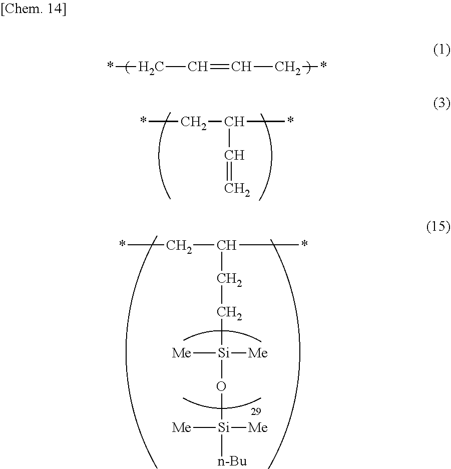

wherein asterisk * has a meaning same as above.

Into a 1 L separable flask equipped with a stirrer, a reflux condenser, a dropping funnel, and a thermometer, 250 g of Poly bd R-15HT, 250 g of a silicone compound represented by formula (14) above, 300 g of toluene, and platinum-1,3-divinyl-1,1,3,3-tetramethyldisiloxane complex in toluene (5 ppm in terms of platinum atoms) are added and stirred at 100° C. for 8 hours. It was confirmed by ¹H-NMR measurement that the Si—H group had disappeared. Then, the resulting product was subjected to distillation under reduced pressure and filtration to obtain a pale yellow and slightly turbid liquid. The number average molecular weight was 2,400, and it was suggested from this number average molecular weight that the obtained silicone compound was an organic silicon compound-modified copolymer E composed of units represented by formulas (1), (3) and (15) above. The OH value was 50 mg KOH/g, and the number of the hydroxyl group per molecule was 2.2.

### [Example 1-6] Production Method of Organic Silicon Compound-Modified Copolymer F

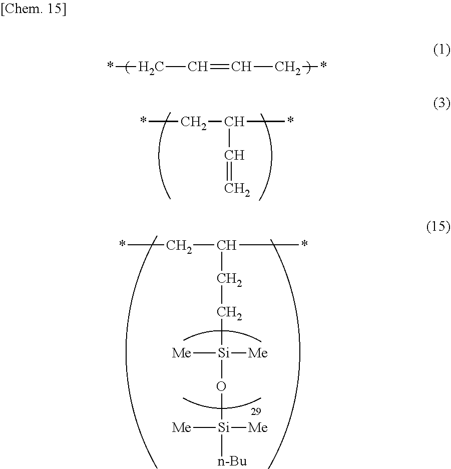

wherein asterisk * has a meaning same as above.

Into a 1 L separable flask equipped with a stirrer, a reflux condenser, a dropping funnel, and a thermometer, 150 g of Poly bd R-15HT, 350 g of a silicone compound represented by formula (14) above, 300 g of toluene, and platinum-1,3-divinyl-1,1,3,3-tetramethyldisiloxane complex in toluene (5 ppm in terms of platinum atoms) are added and stirred at 100° C. for 8 hours. It was confirmed by ¹H-NMR measurement that the Si—H group had disappeared. Then, the resulting product was subjected to distillation under reduced pressure and filtration to obtain a pale yellow and slightly turbid liquid. The number average molecular weight was 4,000, and it was suggested from this number average molecular weight that the obtained silicone compound was an organic silicon compound-modified copolymer F composed of units represented by formulas (1), (3) and (15) above. The OH value was 30 mg KOH/g, and the number of the hydroxyl group per molecule was 2.2.

### [Example 1-7] Production Method of Organic Silicon Compound-Modified Copolymer G

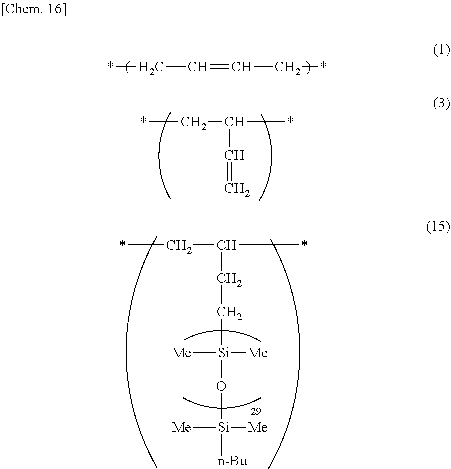

wherein asterisk * has a meaning same as above.

Into a 1 L separable flask equipped with a stirrer, a reflux condenser, a dropping funnel, and a thermometer, 400 g of Poly bd R-45HTLO (manufactured by CRAY VALLEY, the number average molecular weight of 2,800, composed of structural units of formulas (1) and (3) above, (1)/(3)=80/20, OH value of 47 mg KOH/g, the number of hydroxyl groups per molecule of 2.4), 100 g of a silicone compound represented by formula (13) above, 300 g of toluene, and platinum-1,3-divinyl-1,1,3,3-tetramethyldisiloxane complex in toluene (5 ppm in terms of platinum atoms) are added and stirred at 100° C. for 8 hours. It was confirmed by ¹H-NMR measurement that the Si—H group had disappeared. Then, the resulting product was subjected to distillation under reduced pressure and filtration to obtain a pale yellow and slightly turbid liquid. The number average molecular weight was 3,500, and it was suggested from this number average molecular weight that the obtained silicone compound was an organic silicon compound-modified copolymer G composed of units represented by formulas (1), (3) and (15) above. The OH value was 38 mg KOH/g, and the number of the hydroxyl group per molecule was 2.4.

### [2] Confirmation of Compatibility With Component That Constitutes Urethane Composition

### [Examples 2-1 to 2-7, Comparative Examples 2-1 and 2-2]

The compatibility when each of 10 g of the organic silicon compound-modified copolymers A to G obtained above and the silicone compounds A and B below were mixed with 10 g of toluene-2,4-diisocyanate was confirmed and evaluated by the following criteria. The results are shown in Table 1.

◯: Uniformly mixed after 1 week

Δ: Slightly separated after 1 week

X: Separated after 1 hour

TABLE 1

| | | Compatibility |
|---|---|---|
| | Hydroxyl group compound | result |
| Example 2-1 | Organic silicon compound-modified | ○ |
| | copolymer A | |
| Example 2-2 | Organic silicon compound-modified | ○ |
| | copolymer B | |
| Example 2-3 | Organic silicon compound-modified | Δ |
| | copolymer C | |
| Example 2-4 | Organic silicon compound-modified | ○ |
| | copolymer D | |
| Example 2-5 | Organic silicon compound-modified | ○ |
| | copolymer E | |
| Example 2-6 | Organic silicon compound-modified | Δ |
| | copolymer F | |
| Example 2-7 | Organic silicon compound-modified | ○ |
| | copolymer G | |
| Comparative | Silicone compound A | × |
| Example 2-1 | | |
| Comparative | Silicone compound B | × |
| Example 2-2 | | |

Silicone compound A: Dual-end type carbinol-modified silicone KF-6001 (Shin-Etsu Chemical Co., Ltd.)
Silicone compound B: Dual-end type carbinol-modified silicone KF-6002 (Shin-Etsu Chemical Co., Ltd.)

As shown in Table 1, it is found that the organic silicon compound-modified copolymers A to G obtained in Examples 1-1 to 1-7 exhibit high compatibility with the isocyanate compound.

### [3] Production of Urethane Composition and Cured Product

### Examples 3-1 to 3-7

The organic silicon compound-modified copolymers A to G obtained above and polymethylene polyphenyl polyisocyanate (manufactured by Mitsui Chemicals, Inc. COSMONATE 400) were mixed at NCO/OH (molar ratio) of 1.05, and further methyl ethyl ketone (MEK) and NEOSTANN U-830 (manufactured by NITTO KASEI Co., Ltd., dioctyltin dineodecanoate) were mixed as shown in Table 2. The mixed urethane to composition (20 g) was poured into a 170 mm×130 mm×1 mm mold and cured at 25° C. for 1 hour and at 100° C. for 1 hour. The water contact angle and moisture vapor transmission rate of the obtained cured product were measured. The results are also shown in Table 2.

TABLE 2

| | | Example | Example | Example | Example | Example | Example | Example |
|---|---|---|---|---|---|---|---|---|
| | | 3-1 | 3-2 | 3-3 | 3-4 | 3-5 | 3-6 | 3-7 |
| <Mixing ratio (parts by weight)> | | | | | | | | |
| Organic silicon | A | 100 | | | | | | |
| compound-modified | B | | 100 | | | | | |
| copolymer | C | | | 100 | | | | |
| | D | | | | 100 | | | |
| | E | | | | | 100 | | |
| | F | | | | | | 100 | |
| | G | | | | | | | 100 |

| | | | | | | | |
|---|---|---|---|---|---|---|---|
| COSMONATE 400 | 20 | 13 | 7.6 | 20 | 13 | 7.6 | 10 |
| NEOSTANN U-830 | 0.1 | 0.1 | 0.1 | 0.1 | 0.1 | 0.1 | 0.1 |
| MEK | 120 | 113 | 108 | 120 | 113 | 108 | 110 |

<Physical properties of cured product>

| | | | | | | | |
|---|---|---|---|---|---|---|---|
| Water contact angle (°) | 105 | 106 | 108 | 105 | 106 | 108 | 105 |
| Moisture vapor transmission | 25 | 60 | 80 | 25 | 60 | 80 | 25 |
| rate (g/m² · day) | | | | | | | |

### Comparative Examples 3-1 to 3-2

The silicone compounds A and B above and polymethylene polyphenyl polyisocyanate (manufactured by Mitsui Chemicals, Inc., COSMONATE 400) were mixed at NCO/OH (molar ratio) of 1.05, and further MEK solvent and NEOSTANN U-830 were mixed as shown in Table 3. The mixed urethane composition (20 g) was poured into a 170 mm×130 mm×1 mm mold and cured at 25° C. for 1 hour and at 100° C. for 1 hour. The water contact angle and moisture vapor transmission rate of the obtained cured product were measured. The results are also shown in Table 3.

TABLE 3

| Com- | Com- |
|---|---|
| parative | parative |
| Example | Example |
| 3-1 | 3-2 |

<Mixing ratio (parts by weight)>

| | | |
|---|---|---|
| Silicone compound A | 100 | |
| Silicone compound B | | 100 |
| COSMONATE 400 | 16 | 8.9 |
| NEOSTANN U-830 | 0.1 | 0.1 |
| MEK | 116 | 109 |

<Physical properties of cured product>

| | | |
|---|---|---|
| Water contact angle (°) | 105 | 105 |
| Moisture vapor transmission | 140 | 145 |
| rate (g/m² · day) | | |

As shown in Tables 2 and 3, it is found that by using the urethane composition including the organic silicon compound-modified copolymers A to G obtained in Examples 1-1 to 1-7, a cured product having excellent water repellency and moisture resistance can be obtained.

1. An organic silicon compound-modified copolymer comprising: a structural unit of formula (1) below; a structural unit of formula (2) below; and a hydroxyl group at at least one end: 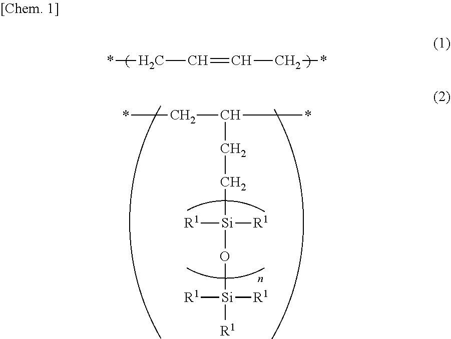
wherein asterisk * is a bond to an adjacent structural unit, R¹ is each independently a C₁-C₁₀ alkyl group or C₆-C₁₀ aryl group, and n is an integer of 1 or higher.

2. The organic silicon compound-modified copolymer of claim 1, having a number average molecular weight of 1,000 or higher.

3. A production method of the organic silicon compound-modified copolymer of claim 1, comprising the step of: hydrosilylating a polybutadiene compound including a structural unit of formula (1) below, a structural unit of formula (3) below, and a hydroxyl group at at least one end with a silicone compound of formula (4) below in presence of a platinum compound-containing catalyst: 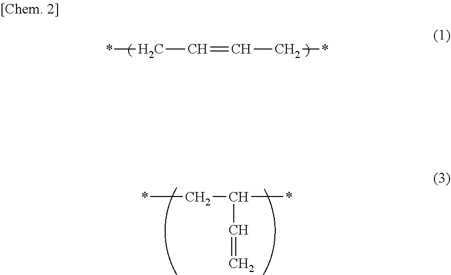
wherein asterisk * has a meaning same as above, 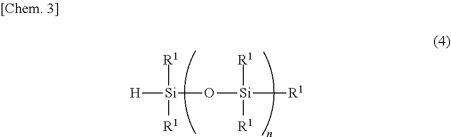
wherein R¹ and n have a meaning same as above.

4. A urethane composition comprising the organic silicon compound-modified copolymer of claim 1.
